(19) United States
(12) Patent Application Publication
(10) Pub. No.: US 2011/0277586 A1
(43) Pub. Date: Nov. 17, 2011

(54) HANDLEBAR GRIP

(76) Inventor: Tsai-Yun YU, Taichung County (TW)

(21) Appl. No.: 12/979,932

(22) Filed: Dec. 28, 2010

(30) Foreign Application Priority Data
May 13, 2010 (TW) 99115329

(51) Int. Cl. B62K 21/26

(52) U.S. Cl. 74/551.9

(57) ABSTRACT

A handlebar grip comprises a sleeve, a clamping device and a fastening means. The sleeve made of rigid plastic materials includes a cylindrical body, a front opening end, a rear opening end and at least a vacant area near the rear opening end. The clamping device includes a ring-shaped body, a first extending end and a second extending end. A slot is defined by the first and second extending ends. The clamping device further has at least a protruding disposed on the inner surface of the body. The clamping device is fitted around the rear opening end of the sleeve in such a way that the protruding of the clamping device is wedged into the vacant area of the sleeve. The fastening means includes a threaded bore and a screw. The bore extends through the first and second extending ends of the clamping device along a reference axis. The screw has a shaft with a proximal end and a distal end opposite the proximal end, a head disposed on the proximal end and a threaded region. The screw is adapted for insertion into the bore such that when the screw is advanced, the width of the slot of the clamping device is reduced and in the same time a fastening force is produced radially inwardly toward the rear end of the sleeve so that the sleeve can be firmly mounted on the handlebars.

### BACKGROUND OF THE INVENTION

1. Field of the Invention

The present invention relates to grips for the handlebars of a bicycle, and more particularly to a grip which can be firmly mounted to and easily removed from the handlebars of a bicycle.

2. Description of the Related Art

It is known that traditional grips are formed by a substantially cylindrical body which is made of plastic material, is internally hollow and can be inserted onto the ends of handlebars generally formed by suitably shaped metal tubes.

Such prior art grips are designed to have a particular inner diameter being somewhat smaller than the outer diameter of the handlebars so that they can be tightly mounted thereon for avoiding slippage between the grip and the handlebar. Because of this, the mounting as well as the removal of such grips is difficult and time-consuming.

Another problem with such conventional grips is that they can slacken due to factors of aging or environmental impact such as, for example, rain, snow, heat or cold; particularly under high stress, this slackening can lead to these grips loosening from the handlebars, respectively sliding off same, thus creating a hazardous situation for the rider. For eliminating the drawbacks of the abovementioned known art, U.S. Pat. No. 6,421,879 disclosed a grip which included a cylindrical sleeve having a lengthwise slot extending the entire length of the sleeve and an end clamp affixing the sleeve onto the handlebar inserted into said sleeve. The lengthwise slot in the cylindrical sleeve allows the grip to accommodate slight variations in the outer diameter of various handlebars. The clamp may be positioned in at least one first open position and at least one second clamping position. The width of the sleeve slot is greater in the open position than in the clamping position so that a reliable clamping is achieved. However, it is believed that the lengthwise slot extending the entire length of the sleeve results in the sleeve being subject to torsional deformation or twisting when a torsional force or torque is applied to the grip by a user.

The present invention is directed toward overcoming one or more of the disadvantages discussed above.

### SUMMARY OF THE INVENTION

A handlebar grip according to the present invention comprises a sleeve, a clamping device and a fastening means.

The sleeve includes a cylindrical body, a front opening end, a rear opening end and at least a vacant area near the rear opening end.

The clamping device includes a ring-shaped body, a first extending end and a second extending end. A slot is defined by the first and second extending ends. The inner surface of the body is disposed to have at least a protruding. In combination, the clamping device is fitted around the rear opening end of the sleeve in such a way that the protruding of the clamping device is wedged into the vacant area of the sleeve.

The fastening means includes a threaded bore and a screw. The bore extends through the first and second extending ends of the clamping device along a reference axis. The screw has a shaft with a proximal end and a distal end opposite the proximal end, a head disposed on the proximal end and a threaded region. The screw is adapted for insertion into the bore such that when the screw is advanced, the width of the slot of the clamping device is reduced and in the same time a fastening force is produced radially inwardly toward the rear end of the sleeve so that the sleeve can be firmly mounted on the end of the handlebars.

### BRIEF DESCRIPTION OF THE DRAWINGS

Further features and advantages of the present invention will be more clearly understood from the detailed description of a preferred, but not exclusive embodiment of a handlebar grip according to the present invention, illustrated by way of a non-limiting example with the assistance of the accompanying drawings, in which:

FIG. 1 is a overall side view of an embodiment of the handlebar grip according to the present invention;

FIG. 2 is an exploded view of the handlebar grip shown FIG. 1;

FIG. 3 is a cross-sectional side view of the sleeve of the handlebar grip shown in FIG. 1 along the line 3-3 of FIG. 2;

FIG. 4 is a sectional side view of the clamping device of the handlebar grip shown in FIG. 1 along the line 4-4 of FIG. 2; and

FIG. 5 is a sectional side view of the handlebar shown in FIG. 1 along the line 5-5 of FIG. 1.

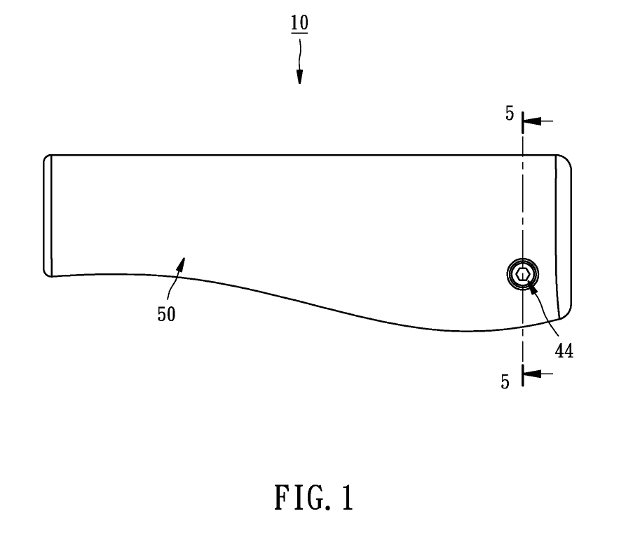

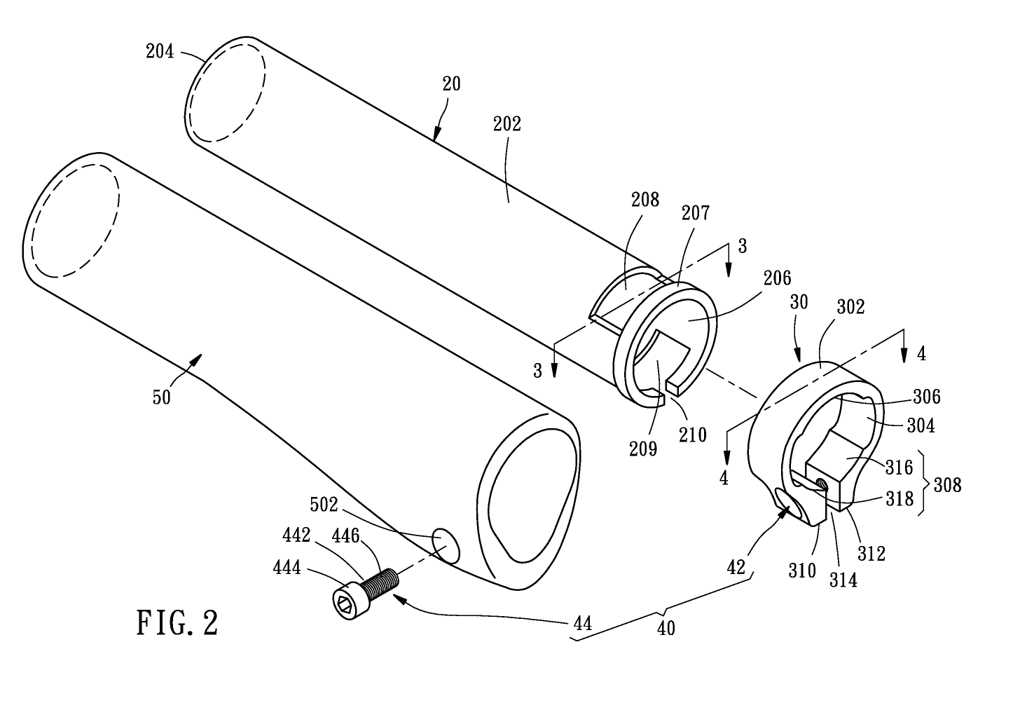

### DETAILED DESCRIPTION OF THE INVENTION

Please referring to the drawings, handlebar grip 10 is a preferred embodiment according to the present invention. It includes a sleeve 20, a clamping device 30, a fastening means 40 and a covering 50.

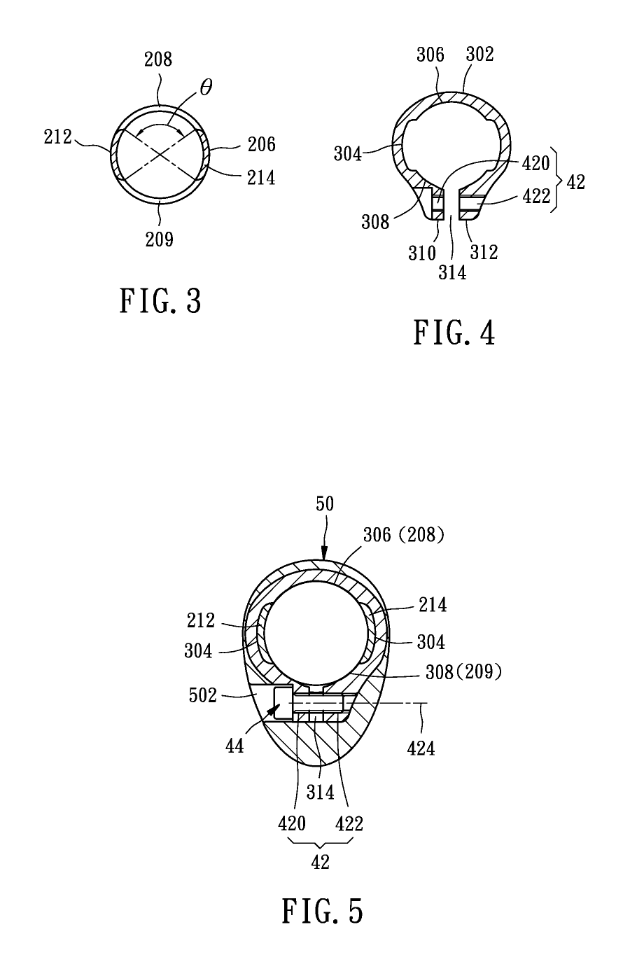

Sleeve 20 in this embodiment is molded from rigid plastic materials and has a cylindrical body 202 with a circularly shaped cross section. Sleeve 20 further has a front opening end 204, a rear opening end 206 with a flange edge 207, a first vacant area 208 and a second vacant area 209 oppositely disposed near rear opening end 206. Each of vacant areas 208, 209 has an arced cross section with a central angle θ between π/6 to ⅔π. It is believed that the preferred central angle θ is ⅔π (shown in FIG. 3). Flange edge 207 of rear opening end 206 of sleeve 20 has a gap 210 corresponding to second vacant area 209. The width of gap 210 is smaller than that of second vacant area 209.

Clamping device 30 is made of metal materials and has a ring-shaped body 302 with an annular inner surface 304, a first extending end 310, a second extending end 312 and a slot 314 defined by first and second extending ends 310,312. Body 302 has a first protruding 306 and a second protruding 308 which are disposed oppositely on annular inner surface 304. In this embodiment, second protruding 308 is divided into a right part 316 and a left part 318 by slot 314. In combination, clamping device 30 fits around rear opening end 206 of sleeve 20 in such a way that first protruding 306 is wedged into first vacant area 208 of sleeve 20, and second protruding 308 is wedged into second vacant area 209 of sleeve 20(as shown in FIG. 5).

Fastening means 40 includes a threaded bore 42 and a screw 44. Threaded bore 42 has a first portion 420 disposed on first extending end 310 of clamping device 30 and extending along axis 424, a second portion 422 disposed on first extending end 312 of clamping device 30 and also extending along axis 424. First and second portions 420,422 are coupled together by means of threaded engagement with screw 44.

Screw 44 has a shaft 442 with a proximal end and a distal end opposite the proximal end, a head 444 disposed on the proximal end and a threaded region 446. Screw 44 is inserted into bore 42 such that when screw 44 is advanced, the width of slot 314 of clamping device 30 is reduced and in the same time a fastening force is produced radially inwardly toward the surface of rear end 204 of sleeve 20 so that sleeve 20 can be tightly clamped on a bicycle handlebar.

In this embodiment, grip 10 further includes a covering 50 made from an anti-skid, relatively elastic material such as naturally grown or synthetically manufactured rubber or sponge rubber. Covering 50 encloses sleeve 20 and clamping device 30 both.

Covering 50 has a through hole 502 corresponding to threaded bore 42 of fastening means 40 so that screw 44 of fastening means 40 can be from outside directly inserted into threaded bore 42 through hole 502.

For having a specific design disclosed above which can produce a bigger fastening force than prior art, handlebar grip 10 will be firmly secured to a bicycle handlebar and will not be subjected to torsional deformation or twisting when a torsional force or torque is applied thereto by a user.

What is claimed is:

1. A handlebar grip for bicycles, comprising:
a sleeve including a cylindrical body, a front opening end, a rear opening end and at least a first vacant area near said rear opening end;
a clamping device including a ring-shaped body with an annular inner surface, a first extending end, a second extending end, a slot defined by said first and second extending ends and at least a first protruding disposed on said annular inner surface of said body; said clamping device fitted around said rear opening end of said sleeve in such a way that said first protruding of said clamping device is wedged into said first vacant area of said sleeve; and
a fastening means including a threaded bore and a screw, said threaded bore extending through said first and second extending ends of said sleeve along a reference axis, said screw having a shaft with a head on a proximal end thereof, said shaft having a distal end opposite said proximal end, said shaft having at said distal end a threaded region;
said screw being adapted for insertion into said threaded bore such that when said screw is advanced, the width of said slot of said clamping device is reduced and in the same time a fastening force is formed radially toward said rear opening end of said sleeve.

2. The handlebar grip of claim 1, further comprising a covering enclosing said sleeve and said clamping device.

3. The handlebar grip of claim 1, wherein the cross section of said sleeve is circularly shaped.

4. The handlebar grip of claim 3, wherein said first vacant area has an arced cross section with a central angle θ between π/6 to ⅔π.

5. The handlebar grip of claim 3, wherein said sleeve further has a second vacant area disposed oppositely to said first vacant area.

6. The handlebar grip of claim 5, wherein each of said first and second vacant areas has an arced cross section with a central angle θ between π/6 to ⅔π.

7. The handlebar grip of claim 5, wherein said sleeve further has a flange edge disposed on said rear opening end thereof

8. The handlebar grip of claim 7, wherein said flange edge of sleeve has a gap corresponding to second vacant area and with a width smaller than that of said second vacant area.

9. The handlebar grip of claim 5, wherein said clamping device further has a second protruding disposed on said annular inner surface of said body and being opposite to said first protruding thereof so that when said clamping device is fitted around said rear opening end of said sleeve, said second protruding of said clamping device is wedged into said second vacant area of said sleeve.

10. The handlebar grip of claim 9, wherein said second protruding is divided into a right part and a left part by said slot.

11. The handlebar grip of claim 2, wherein said covering has a hole corresponding to said threaded bore of said fastening means so that said screw of said fastening means can be directly inserted into said threaded bore from outside.
